(19) United States
(12) Patent Application Publication
(10) Pub. No.: US 2018/0047370 A1
(43) Pub. Date: Feb. 15, 2018

(54) DISPLAY CONTROLLER AND OPERATION METHOD THEREOF

(71) Applicant: MStar Semiconductor, Inc., Hsinchu Hsien (TW)

(72) Inventors: Dien-Shen Chiang, Hsinchu Hsien (TW); Tun Chieh Yang, Hsinchu Hsien (TW)

(21) Appl. No.: 15/427,315

(22) Filed: Feb. 8, 2017

Related U.S. Application Data
(60) Provisional application No. 62/374,000, filed on Aug. 12, 2016.

(51) Int. Cl. G09G 5/399; G06F 3/06; G09G 5/36

(52) U.S. Cl. CPC G09G 5/399; G09G 5/363; G06F 3/061; G06F 3/0655; G06F 3/0688; G06F 3/065

(57) ABSTRACT

A display controller includes a plurality of memories and an enable control circuit. Each of the memories stores one set of extended display identification data (EDID). The enable control circuit selects and enables one of the memories and disables the remaining memories to allow a source device to read the corresponding EDID stored in the enabled memory.

This application claims the benefit of U.S. Provisional Application Ser. No. 62/374,000, filed Aug. 12, 2016, the subject matter of which is incorporated herein by reference.

### BACKGROUND OF THE INVENTION

### Field of the Invention

The invention relates in general to a display controller, and more particularly to a display controller capable of providing extended display identification data (EDID) and an operation method thereof.

### Description of the Related Art

Extended display identification data (EDID) is a set of data defined by the Video Electronics Standard Association (VESA), and is targeted at informing a source device connected to a display device of a capability that the display device provides, e.g., a resolution and a playback frequency of video. The EDID is usually stored in an electrically-erasable programmable read-only memory (EEPROM) coordinating with a display controller. A source device, for example, a personal computer or a multimedia player, may obtain the EDID of the display device through a query and then may provide an appropriate video format for the display device to display. In some circumstances, a display system needs to store a plurality of sets of EDID for a user to choose from. Therefore, how to concisely and effectively respond to a user choice to allow a source device to read the correct set from multiple sets of EDID is essential.

### SUMMARY OF THE INVENTION

It is an object of the present invention to provide a display controller capable of supporting switching among multiple sets of extended display identification data (EDID).

It is another object of the present invention to provide a display controller, which achieves a function of switching EDID without rewriting an electrically-erasable programmable read-only memory (EEPROM).

It is yet another object of the present invention to provide a display controller, which achieves a function of switching EDID without involving an additional inter-integrated circuit (I²C) bus channel switcher.

A display controller is provided according to an embodiment of the present invention. The display controller includes a first memory, a second memory and an enable control circuit. The first memory stores first EDID. The second memory stores second EDID. The enable control circuit outputs a first control signal to control enabling and disabling of the first memory, and outputs a second control signal to control enabling and disabling of the second memory.

A display controller is provided according to another embodiment of the present invention. The display controller includes a plurality of memories and an enable control circuit. Each of the memories stores one set of EDID. The enable control circuit selects and enables one of the memories, and disables the remaining memories to allow a source device to read the corresponding EDID stored in the enabled memory.

A method for providing EDID is provided according another embodiment of the present invention. The method includes providing a plurality of memories, storing one set of EDID data into each of the memories, and enabling one of the memories and disabling the remaining memories to allow a source device to read the corresponding EDID stored in the enabled memory.

A method for providing EDID is provided according to another embodiment of the present invention. The method includes storing first EDID into a first memory, storing second EDID into a second memory, receiving an EDID selection signal by a controller, enabling the first memory and disabling the second memory by the controlling when the selection signal indicates to select the first EDID, and enabling the second memory and disabling the first memory by the controller when the selection signal indicates to select the second EDID.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a display system according to an embodiment of the present invention;

FIG. 2 is a flowchart of a process for providing correct EDID;

FIG. 3 is a block diagram of a display system according to another embodiment of the present invention;

FIG. 4 is a block diagram of a display system according to yet another embodiment of the present invention;

FIG. 5 is a flowchart of a method for providing EDID according to an embodiment of the present invention; and

FIG. 6 is a flowchart of a method for providing EDID according to another embodiment of the present invention.

### DETAILED DESCRIPTION OF THE INVENTION

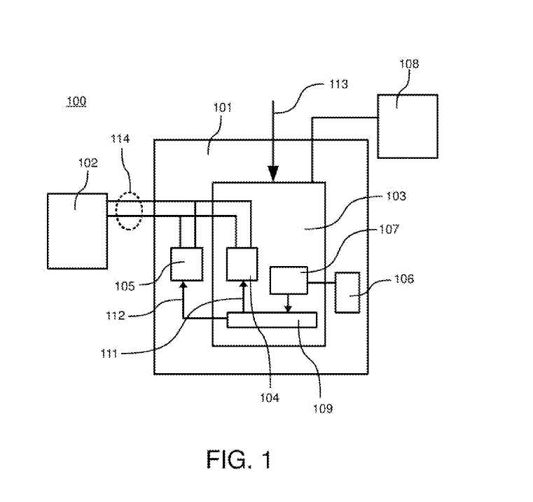

FIG. 1 shows a block diagram of a display system according to an embodiment. Referring to FIG. 1, a display system 100 includes a source device 102, a display controller 102 and a display device 108. The display controller 101 includes a scalar 103. The display controller 102 includes a first memory 104, a second memory 105 and a third memory 106. The first memory 104 is connected to the source device 102 by an inter-integrated circuit (I²C) bus 114, and the second memory 105 is also connected to the I²C bus 114. The first memory 104 stores first extended display identification data (EDID), to be referred to as EDID 1. The second memory 105 stores second extended display identification data, to be referred to as EDID 2. The EDID includes data associated with a resolution and a playback frequency of a display device. When the display system 100 is to play video, the source device 102 needs to first obtain the EDID in order to provide appropriate video data. In some embodiments, the display controller 102 requires capabilities of supporting different resolutions and different playback frequencies, and so the display controller 101 needs to provide multiple sets of EDID for the source device 102 to read.

In one embodiment, the first memory 104 is a static random access memory (SRAM), the second memory 105 is an electrically-erasable programmable read-only memory (EEPROM), and the third memory 106 is a flash memory. In one embodiment, the display controller 101 includes a scalar 103, in which the first memory 104 is disposed. In one embodiment, the scalar 103 includes a controller 107, which may e a microcontroller unit (MCU). In one embodiment, the scalar 103 includes an enable control circuit 109, which controls enabling or disabling of the first memory 104 and the second memory 105. For example, the enable control circuit 109 may control the first memory 104 to become enabled or disabled through a first control signal 111, and controls the second memory 105 to be enabled or disabled through a second control signal 112. When the first memory 104 is enabled, the source device 102 may read the EDID 1 in the first memory 104. When the second memory 105 is enabled, the source device 102 may read the EDID 2 in the second memory 105. Enabling or disabling the first memory 104 may be achieved through general-purpose input/output (GPIO), and enabling or disabling the second memory 105 may also be achieved through GPIO. In one embodiment, the first memory 104 is disabled by changing a setting value in a register of the first memory 104, and the second memory 105 is disabled by disconnecting power of the second memory 105 or isolating a signal inputted into the second memory 105. More specifically, regarding the mechanism of power disconnection, a switch may be provided on a power path, and the power provided to the memory may be controlled through the switch.

The MCU 107 may provide correct EDID through the enable control circuit 109 after receiving a selection input from a user. In one embodiment, the MCU 107 receives a selection signal 113 from a user. When the selection signal 113 selects the EDID 1, the MCU 107 enables the first memory 104 and disables the second memory 105 through the first control signal 111, hence allowing the source device 102 to read the EDID 1 stored in the first memory 102. When the selection signal 113 selects the EDID 2, the MCU 107 enables the second memory 105 and disables the first memory 104 through the second control signal 112, hence allowing the source device 102 to read the EDID 2 stored in the second memory 105. It should be noted that, the EDID 1 stored in an SRAM vanishes when power is disconnected from the SRAM. Thus, when the first memory 104 is implemented by an SRAM, the MCU 107 obtains the EDID 1 from the flash memory 106 once the power is restored and stores the EDID 1 to the first memory 104. In one embodiment, the first memory 104, the MCU 107 and the enable control circuit 109 are disposed in the same chip.

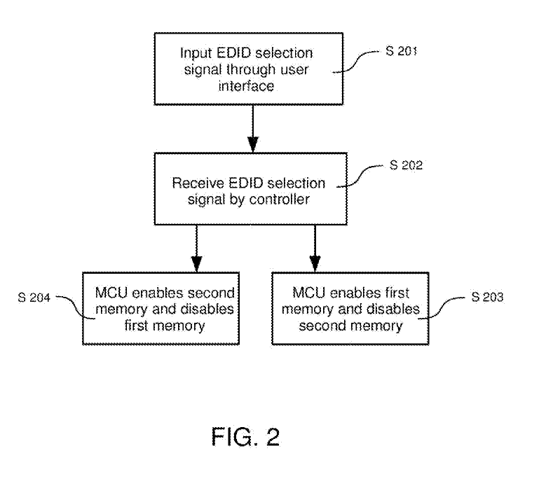

FIG. 2 shows a flowchart of a process of providing correct EDID. Referring to FIG. 2, an EDID selection signal is inputted via a user interface (step S201). The user interface may be a keyboard, a display device or other interfaces that receive inputs. The user may select one most appropriate from multiple EDID versions. The EDID selection signal is received by a controller (step S202). The controller may be a microcontroller unit (MCU). When the selection signal selects the EDID 1, the MCU enables the first memory and disables the second memory (step S203). When the selection signal selects the EDID 2, the MCU enables the second memory and disables the first memory (step S204). In one embodiment, the first memory is an SRAM, and the second memory is an EERPOM.

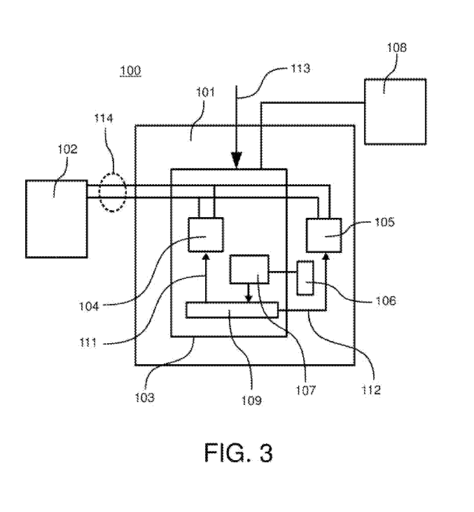

FIG. 3 shows a block diagram of a display system according to another embodiment of the present invention. Referring to FIG. 3, the display system 100 is similar to the display system 100 in FIG. 1, with one difference being that the first memory 104 and the second memory 105 are connected to the I²C bus 114 in a different order. In FIG. 1, the I²C bus is first connected to the second memory 105 and then connected to the first memory 104. However, in FIG. 3, the I²C bus 114 is first connected to the first memory 104 and then connected to the second memory 105. In the embodiment in FIG. 3, the control method is the same as that in FIG. 1 although the connection order is different.

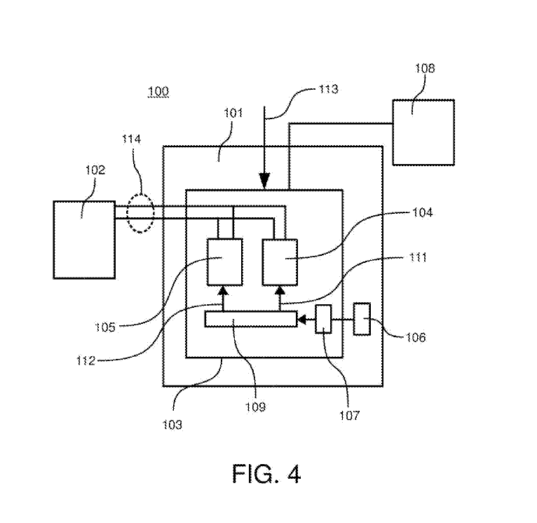

FIG. 4 shows a block diagram of a display system according to another embodiment of the present invention. Referring to FIG. 4, the display system 100 includes the first memory 104, the second memory 105 and the third memory 106. The first memory 104 and the second memory 105 are SRAMs, and the third memory 106 is a flash memory 106. The first memory 104 and the second memory 105 are disposed in the scalar 103. In one embodiment, the MCU 107 receives a selection signal 113 from a user. When the selection signal 113 selects the EDID 1, the MCU 107 enables the first memory 104 and disables the second memory 105 through the first control signal 111 to allow the source device 102 to read the EDID 1 stored in the first memory 104. When the selection signal 113 selects the EDID 2, the MCU enables the second memory 105 and disables the first memory 104 through the second control signal 112 to allow the source device 102 to read the EDID 2 stored in the second memory 105. It should be noted that, the EDID 1 and EDID 2 stored in SRAMs vanishes when power is disconnected from the SRAMs. Thus, once the power is restored, the MCU 107 obtains the EDID 1 and the EDID 2 from the flash memory 106, and stores the EDID 1 and the EDID 2 to the first memory 104 and the second memory 105, respectively.

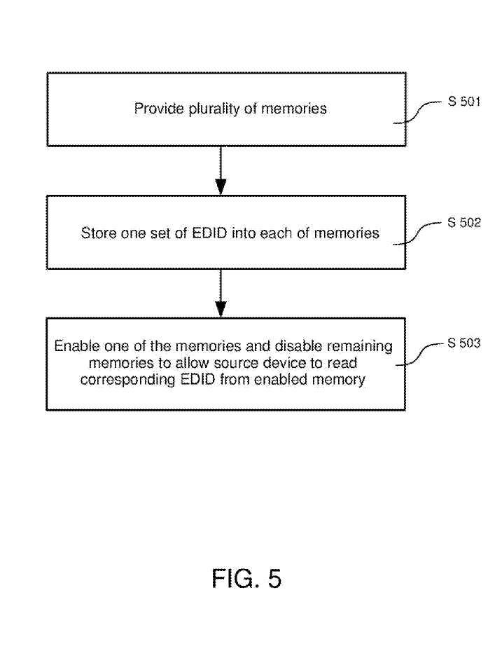

FIG. 5 shows a flowchart of a method for providing EDID according to an embodiment. Referring to FIG. 5, a plurality of memories are provided (step S501). One set of EDID is stored into each of the memories (step S502). One of the memories is enabled and the remaining memories are disabled to allow a source device to read the corresponding EDID stored in the enabled memory (step S503).

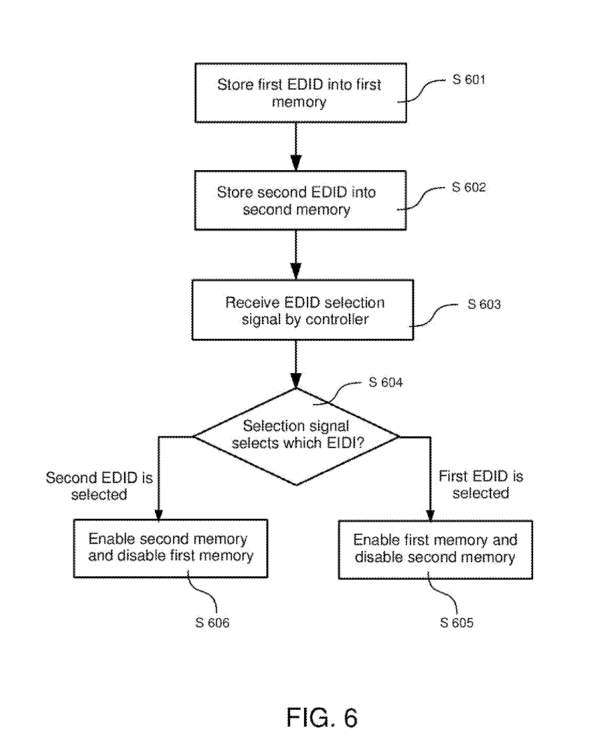

FIG. 6 shows a flowchart of a method for providing EDID according to another embodiment. Referring to FIG. 6, first EDID is stored into a first memory (step S601). Second EDID is stored into a second memory (step S602). An EDID selection signal is received by a controller (step S603). It is determined which EDID the selection signal selects (step S604). When the selection signal selects the first EDID, the first memory is enabled and the second memory is disabled by the controller (step S605). When the selection signal selects the second EDID, the second memory is enabled and the first memory is disabled by the controller (step S606).

Compared to a conventional approach of providing EDID, the present invention is not required to write correct EDID into an EEPROM nor provide an additional chip that provides EDID in the system, and thus provides outstanding features.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display controller, comprising:
a first memory, storing first extended display identification data (EDID);
a second memory, storing second EDID; and
an enable controller, outputting a first control signal to control enabling and disabling of the first memory, and a second control signal to control enabling and disabling of the second memory.

2. The display controller according to claim 1, further comprising:
a scalar, comprising a microcontroller unit (MCU) and the enable controller, the MCU controlling enabling and disabling of the first memory and the second memory through the enable controller according to a selection signal.

3. The display controller according to claim 2, further comprising:
a third memory, connected to the MCU, being a flash memory.

4. The display controller according to claim 1, wherein the first memory is a static random access memory (SRAM), and the second memory is an electrically-erasable programmable read-only memory (EEPROM).

5. The display controller according to claim 1, wherein the first memory and the second memory are connected to an inter-integrated circuit (I²C) bus.

6. The display controller according to claim 1, wherein the first memory allows a source device to read the first EDID when the enable controller enables the first memory, and does not allow the source device to read the first EDID when the enable controller disables the first memory.

7. The display controller according to claim 1, wherein the second memory allows a source device to read the second EDID when the enable controller enables the second memory, and does not allow the source device to read the second EDID when the enable controller disables the second memory.

8. A display controller, comprising:
a plurality of memories, each storing one set of extended display identification data (EDID); and
an enable controller, selecting and enabling one of the plurality of memories and disabling the remaining memories to allow a source device to read the corresponding EDID stored in the enabled memory.

9. The display controller according to claim 8, wherein the memories comprise at least one static random access memory (SRAM) and at least one electrically-erasable programmable read-only memory (EEPROM).

10. The display controller according to claim 8, further comprising:
a scalar, comprising a microcontroller unit (MCU) and the enable controller, the MCU receiving a selection signal and controlling enabling and disabling of the memories through the enable controller.

11. The display controller according to claim 10, further comprising a flash memory connected to the MCU.

12. The display controller according to claim 8, wherein the memories are connected to an inter-integrated circuit (I²C) bus that is connected to the source device.

13. The display controller according to claim 8, wherein the memories are SRAMs.

14. A method for providing extended display identification data (EDID), comprising:
providing a plurality of memories;
storing one set of EDID into each of the memories; and
enabling one of the memories and disabling the remaining memories to allow a source device to read the corresponding EDID stored in the enabled memory.

15. The method according to claim 14, wherein the memories comprise at least one static random access memory (SRAM) and at least one electrically-erasable programmable read-only memory (EEPROM).

16. The method according to claim 14, further comprising:
receiving a selection signal by a microcontroller unit (MCU); and
controlling enabling and disabling of the memories by an enable controller according to the selection signal.

17. The method according to claim 14, wherein the step of disabling the remaining memories comprises:
disconnecting power from the remaining memories.

18. A method for providing extended display identification data (EDID), comprising:
storing first EDID into a first memory;
storing second EDID into a second memory;
receiving an EDID selection signal by a controller;
enabling the first memory and disabling the second memory when the selection signal indicates to select the first EDID; and
enabling the second memory and disabling the first memory when the selection signal indicates to select the second EDID.

19. The method according to claim 18, wherein the first memory and the second memory are connected to an inter-integrated circuit (I²C) bus.

20. The method according to claim 18, wherein the first memory is a static random access memory (SRAM), and the second memory is an electrically-erasable programmable read-only memory (EEPROM).
